(19) United States
(12) Patent Application Publication
(10) Pub. No.: US 2005/0159994 A1
(43) Pub. Date: Jul. 21, 2005

(54) Method and apparatus for plan generation

(76) Inventors: David E. Huddleston, Lakewood, OH (US); Ronald J. Cass, Cleveland Heights, OH (US); Zhuo Meng, Broadview Heights, OH (US); Yoh-Han Pao, Cleveland Heights, OH (US); Ella Polyak Goykhberg, Mayfield Heights, OH (US); Baofu Duan, Cleveland Heights, OH (US); Michael E. Parish, Lakewood, CA (US)

Correspondence Address: COOPER & DUNHAM, LLP, 1185 AVENUE OF THE AMERICAS, NEW YORK, NY, 10036, US

(21) Appl. No.: 10/887,654

(22) Filed: Jul. 9, 2004

Related U.S. Application Data
(60) Provisional application No. 60/487,035, filed on Jul. 11, 2003.

(51) Int. Cl. G06F 17/60

(52) U.S. Cl. 705/10

(57) ABSTRACT

A method for plan generation is provided. One or more initial plans are generated and evaluated to determine quality scores for the plans. One or more of the plans is selected according to the quality scores and modified to generate modified plans. The modified plans are evaluated to determine updated quality scores for the modified plans. Selection, modification and evaluation of modified plans are repeated until one of the modified plans is satisfactory.

### CROSS-REFERENCE TO RELATED APPLICATION

This application claims the benefit of commonly owned U.S. Provisional Application Ser. No. 60/487,035, filed Jul. 11, 2003 and entitled “ENCAPSULATED PLANNING OPTIMIZATION”.

### TECHNICAL FIELD

This application relates to planning and/or scheduling problems. In particular, the application relates to optimization of plan and/or schedule generation.

### DESCRIPTION OF RELATED ART

Planning and scheduling are interesting problems in both the academic and business worlds. For example, the knapsack problem and the traveling salesman problem (TSP) are well-known academic problems.

Planning and scheduling of personnel shifts, vehicle (for example, truck, aircraft, cargo ship, etc.) scheduling, route planning, etc., are examples of factors for improving efficiency of a business process. The possible list of business and industrial planning/scheduling applications is quite large.

Planning and scheduling problems are usually NP-hard (that is, the problem can be attacked deterministically in exponential time, or nondeterministically in polynomial time by following an arbitrary number of paths). Traditional search techniques, such as breadth-first, depth-first, A*, etc., cannot be used on such problems since the computational load grows exponentially, or non-polynomially, as the size of the problem (for example, number of items to schedule) grows linearly.

Therefore, traditionally, such a problem is dealt with using heuristic rules such as largest unit value first for the knapsack problem, or the nearest neighbor first in case of the TSP. However, such rules seldom give optimal results, and in worst cases the results given by such heuristic rules can be arbitrarily bad compared with the optimal results.

Stochastic search methods can be used to find optimal or at least sub-optimal but satisfactory results for such a problem. Genetic Algorithm (GA) is a popular approach. For example, given a starting guess, GA uses selection, crossover, and mutation operations to evolve new generations, while keeping the best case during the process until it converges. However, using GA generally requires encoding of the problem into a bit string which may not be easy to construct, and if not constructed properly yields results that are not meaningful. Therefore, one must be expert in both the problem domain and the optimization technique, in order to use such a system effectively. Such a requirement frequently limits the usefulness of a stochastic search method on business problems.

The disclosures of the following publications in their entireties are hereby incorporated by reference into this application in order to more fully describe the state of the art as known to those skilled therein as of the date of the invention described and claimed herein:
James Allen, James Hendler, and Austin Tate (Eds.), Readings In Planning, Morgan Kaufmann Publishers, 1990;
Billy E. Gillett, Introduction to Operations Research: A Computer-oriented Algorithmic Approach, McGraw Hill, 1976;
Frederick S. Hiller and Gerald Leiberman, Introduction to Operations Research, The McGraw Hill Companies, 2001;
ICMI, Inc., Call Center Forecasting and Scheduling: The Best of Call Center Management Review, Call Center Press (a division of ICMI, Inc.), 2000;
Drew McDermott et. al., “PDDL—The Planning Domain Definition Language (ver. 1.2),” Yale Center for computational Vision and Control Tech Report CVC TR-98-003/DCS TR-1165, October 1998; and
Michael Pinedo, Scheduling—Theory, Algorithms, and Systems, Prentice Hall, 2002.

### SUMMARY

The application describes methods and apparatuses for plan generation. In one embodiment, a method for plan generation includes (a) generating one or more initial plans, (b) evaluating the plans to determine quality scores for the plans, (c) selecting one or more of the plans according to the quality scores and modifying the selected plans to generate modified plans, (d) evaluating the modified plans to determine updated quality scores for the modified plans, and (e) determining whether at least one of the modified plans is satisfactory. The method can further include repeating (c) through (e) until at least one modified plan is satisfactory.

An apparatus for plan generation, according to one embodiment, includes a planning module and an optimization module. The planning module generates one or more plans, evaluates the plans to determine quality scores for the respective plans, selects one of the plans based on the quality scores, and modifies the selected plan to generate one or more modified plans. The optimization module drives the planning module to develop a plan that is satisfactory.

### BRIEF DESCRIPTION OF THE DRAWINGS

The features of the present application can be more readily understood from the following detailed description with reference to the accompanying drawings wherein:

FIG. 1A shows a schematic diagram of an apparatus for plan generation, according to an embodiment of the present application;

FIG. 1B shows a flow chart for a method for plan generation, according to the embodiment of FIG. 1A;

FIG. 2 shows a flow chart of a method for plan generation, according to another exemplary embodiment;

FIG. 3 shows a flow chart of an Encapsulated Planning Optimization (EPO) methodology; and

FIGS. 4A through 4C show tables corresponding to a scheduling example.

### DETAILED DESCRIPTION

This application provides tools (in the form of methodologies, apparatuses and systems) for plan generation. The tools may be embodied in one or more computer programs stored on a computer readable medium and/or transmitted via a computer network or other transmission medium.

The following exemplary embodiments are set forth to aid in an understanding of the subject matter of this disclosure, but are not intended, and should not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner. For example, the term “plan” as used herein encompasses plans, schedules, other equivalents and products of planning/scheduling, etc.

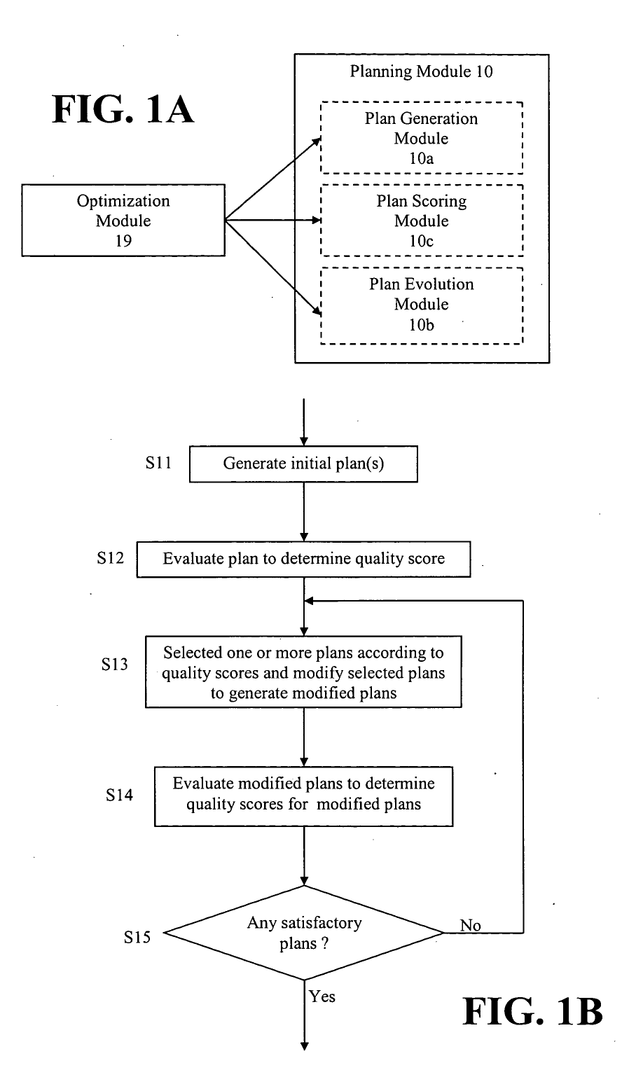

An apparatus and a method for plan generation, according to an embodiment of this application, is described below with reference to FIGS. 1A and 1B. The apparatus includes a planning module 10 and an optimization module 19. The planning module 10 generates one or more plans, evaluates the plans to determine quality scores for the respective plans, selects one of the plans based on the quality scores, and modifies the selected plan to generate one or more modified plans. The optimization module 19 drives the planning module 10 to develop a plan that is satisfactory.

The planning module can optionally include a plan generation submodule 10a, a plan evolution submodule 10b and a plan scoring submodule 10c. The plan generation submodule 10a can generate valid plans by applying heuristics and/or by applying validity rules. The plan evolution submodule 10b can apply evolution rules to generate the modified plans. Alternatively, or in addition, the plan evolution submodule 10b may apply a parameter corresponding to an amount of change to generate the modified plans. The plan scoring submodule 10c evaluates a plan to determine a quality score for the plan. The satisfactory plan typically has a satisfactory associated quality score.

In the method for plan generation, the plan generation submodule 10a generates one or more initial plans (step S11). Validity rules may be used to generate the initial plans. An initial plan can be generated by applying heuristics or randomly.

The plan scoring submodule 10c evaluates the plans to determine quality scores for the plans (step S12). One or more of the plans are selected according to the quality scores and the plan evolution submodule 10b modifies the selected plans to generate modified plans (step S13). A parameter corresponding to an amount of change can be applied to generate at least one modified plan. At least one of the modified plans may be generated by applying evolution rules. The modified plans can be generated using Guided Evolutionary Simulated Annealing. The method may further comprise assessing whether the modified plans are valid plans.

The plan scoring submodule 10c evaluates the modified plans to determine updated quality scores for the modified plans (step S14). The modified plans are examined to determine whether at least one of the modified plans is satisfactory (step S15). A plan may be deemed to be satisfactory if the quality score of the plan is a satisfactory value. Alternatively, a modified plan may be deemed to be satisfactory if a quality score of the modified plan converges.

If none of the modified plans are satisfactory (step S15, No), selection, modification and evaluation (steps S13-S15) of modified plans are repeated until at least one of the modified plans is satisfactory.

A motivation of the tools of this disclosure is to carry out optimization of plans/schedules. The optimization may be based on interaction of rules and stochastic search so that only a minimal set of rules are used as a starting point to generate meaningful results. The process is easy to understand, and can easily be refined and adapted as deeper understandings of the system are available.

The tools of this disclosure can readily be adapted for any of various planning or scheduling applications. For example, the tools can be used for allocating personnel, vehicles, other resources, etc., planning travel routes, scheduling activities, etc., as well as assorted other business or industrial planning/scheduling applications. The tools can be integrated with predictive technology products to build an optimal scheduling application. The tools can also be a component in vertical domain specific software tools, such as for planning/scheduling facilities, workflow, etc.

For illustration purposes, additional exemplary embodiments are described below.

An Encapsulated Planning Optimization (EPO) approach can be used to allow a normal business user to effectively leverage his domain knowledge in the process of planning/scheduling optimization, without being also an expert in optimization techniques. EPO is a generalized procedure for optimal plan generation which can be applied to numerous types of planning problems, ranging from personnel and activity scheduling to staffing and resource planning.

The EPO procedure involves a hybrid methodology combining a rules-based methodology, which is referred to herein as “Planning Rulebase Application” (PRA), for generating fully formulated candidate plans and modifying them in valid ways, coupled with a suitable optimization technique. PRA can simply produce correct although random plans, or it can be refined to include heuristics to generate better than average plans. Correct in the present context means that the plans generated are fully valid, and engender no unrealizable or invalid conditions. Rules or procedures can also be incorporated into PRA to modify fully formulated plans in correct ways (that is, in steps which are realizable and which result in a still valid plan).

Another feature of PRA is that it implements a scoring or objective function mechanism against the plans it generates. Various optimization techniques can work in cooperation with PRA to arrive at optimal plans.

An instance of such an optimization application (OA) is Guided Evolutionary Simulated Annealing (GESA). GESA techniques are also discussed in commonly owned U.S. Provisional Application Ser. No. 60/486,734, filed Jul. 11, 2003 and entitled “GESA ASSISTED FEATURE SELECTION”, which is incorporated by reference herein in its entirety.

GESA permits completely externalizing the aforementioned plan management functions, while retaining the core optimization functionality. Parenthetically, many genetic algorithms (GA) require a standardized representation of optimization candidates as a bit-string, analogous to a DNA strand in nature. Such a bit-string representation is often non-intuitive to implement, and it can overly constrain the eventual results of optimization. Externalizing plan representation and evolution accommodates most real-world planning domains in an intuitive way, and allows specification of wide-ranging and efficient evolutionary rules.

Traditionally PRAs (also sometimes referred to as expert systems), are viewed as a primary or standalone methodology. The utmost effort is exerted in the design of such systems to generate, if not optimal, at least very good plans in one or a few passes. A virtue of EPO is that even starting with random plans, GESA optimization allows the plans to evolve into optimal plans given sufficient time (which of course assumes that the problem is tractable, and that the evolution rules permit free movement throughout the plan design space). Most interesting problems require more than simple trial and error to achieve optimization in a reasonable amount of time. GESA engenders a wide-ranging strategy while efficiently regulating and guiding the optimal search.

Since EPO functions with primitive starting plans, it streamlines the design of planning systems which previously had been preoccupied with generating above average or exemplary plans. However, even sophisticated PRAs which engender heuristics to improve plan generation can benefit from EPO. Testing (discussed below) shows that when heuristics are applied to initial plan generation, optimal plans are achieved more quickly, and that sometimes higher scoring plans are achieved. Thus EPO, PRA and OA have a symbiotic relationship. The OA evolves optimal plans from even a novice PRA, and an expert PRA produces optimal plans faster.

A typical implementation of the EPO approach is composed of two major parts, an optimization module and a Planning Rulebase Application (PRA). The PRA can include functional modules, such as a plan generation module, a plan evolution module and a plan scoring module.

The plan generation module can produce valid random, or heuristically-enhanced, plans. It is generally preferable that the plan generation and evolution modules produce valid plans. A valid plan is a plan that satisfies the constraints in the problem. What is a valid plan usually can be spelled out in rules. The plan generation module can be adapted to follow rules where rules are provided and to use random values where no rule applies.

A simple plan evolution module can be designed similarly by introducing one or more random changes where the rules allow. The plan evolution module can produce one or more alternative valid plans given an existing valid plan and an optional parameter on how much change is to be introduced in producing the alternative plans.

The plan scoring module evaluates the quality of a given plan.

The optimization module can drive the three modules in the PRA to carry out search for optimal solution.

One of the distinctions of the EPO configuration from another optimization system, such as a typical GA system, is that in the EPO system, the plan generation and evolution functions are part of the PRA and external to the optimization module. The EPO structure allows the modules in the PRA to be composed of business rules. The EPO approach, with externalized plan generation and evolution, accommodates most real-world planning domains in an intuitive way, and allows specification of wide-ranging and efficient evolutionary rules.

In comparison, a typical GA system does not contain plan generation or plan evolution modules but only a plan scoring module. The use of the bit-string encoding in GA techniques makes the plan generation and evolution a standard process for all problems and thus it resides inside the GA optimization module. However, the bit-string encoding often engenders difficulty in directly applying available domain knowledge, which is usually available in the form of business rules. One applies care and cleverness, in the process of encoding plans as bit-string. Further, the bit-string representation is fairly rigid and some elements or nuances of a set of business rules may be ignored or weakly expressed. In order to use a typical GA system effectively, one must usually be an expert on both the problem domain and the optimization technique.

However, even though such a simple plan generation module and plan evolution module can eventually achieve optimal results, time constraints for massive problems may not allow such a setup to eventually find the optimal result. Instead, one can start with a reduced scale problem which can obtain optimal results in a reasonable amount of time, and use insights gained from the reduced scale problem to introduce additional, possibly heuristic, rules to the plan generation and evolution modules to achieve optimal results faster and then apply such a setup to the original problem. Heuristic rules based on insights are different from heuristic rules such as picking nearest neighbor in TSP in that the former does not specify a complete solution by itself but still allows randomness in the search process and guides the search in more promising areas of the problem space.

Easy adaptation of the rules also allows the user to carry out what-if analyses by adding or removing a rule to see the effect of it, and thus the user can tweak the outputs easily. For traditional GA encodings, changing the output usually means that the bit string representation is redesigned.

Another type of what-if analysis which can readily be provided to end users of an EPO-based application is to enable users to manually apply the embedded evolution rules against a plan instance, such as a plan recommended by the application as optimal based on the criteria embedded in the PRA. The plan instance can also be the best plan so far in a paused or stopped run, or even a plan the user likes to use as one of the starting plans for an optimization run. The features above allow what-if analysis to be used for user review and acceptance of optimal planning results, and for users to benefit from an incompletely defined PRA, by enabling manual refinements of plans from such an application.

One additional benefit of the EPO approach is that since the plan generation, evolution and scoring are completely external to the optimization process, there is no specified requirement on the representation of the plan. Existing representations from another general planning framework such as STRIPS or PDDL can be adapted for use with the EPO approach. Experiences and insights gained in using such systems can be used to design better plan generation and evolution modules.

The benefits of externalizing the plan generation and evolution also carry a price. The overhead for calling external rule-based routines are much higher compared with shuffling of bit strings. However, with the ever increasing processing power of computers, such a trade off between computational efficiency and ease of use becomes increasingly acceptable.

According to an exemplary embodiment of the EPO approach, the optimization module may use the Guided Evolutionary Simulated Annealing (GESA) optimization technique which allows the externalization of the plan generation and evolution in addition to plan evaluation.

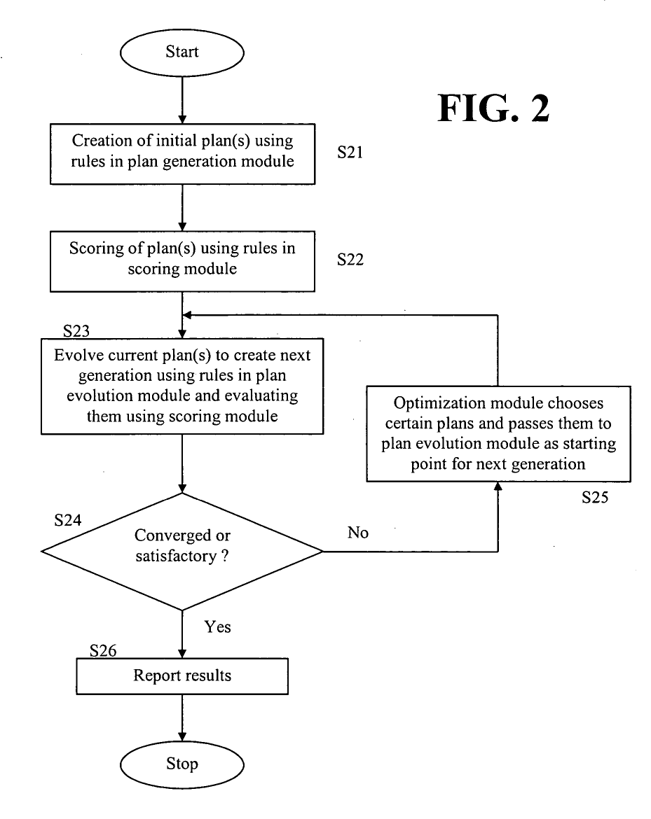

A process for plan generation, according to an exemplary EPO embodiment, is illustrated in FIG. 2. The process can start with the optimization module instructing the plan generation module to create one or more initial plans (step S21). The number of starting plans can be user-configurable. The initial plans are evaluated by the plan scoring module (step S22), such as using a scoring technique. The optimization module can then instruct the plan evolution module to generate another generation of plans based on existing ones (and their scores) and use the plan scoring module to evaluate the new plans (step S23). If no convergence or no satisfactory plan is found (step S24, No), one or more plans are selected and passed to plan evolution for starting the next generation (step S25). This process (steps S23 and S24) can continue until convergence or until the best plan found so far is deemed satisfactory (step S24, Yes). After convergence or a plan is determined to be satisfactory (step S24, Yes), the results can be reported (step S26).

EPO also lends itself very well to early stopping or pausing of the process. One virtue of most GA approaches, GESA included, is that the best solution found so far is always available. Thus, in a time-constrained situation EPO allows a user to view and accept a sub-optimal solution which given the user's available time may be acceptable to the user.

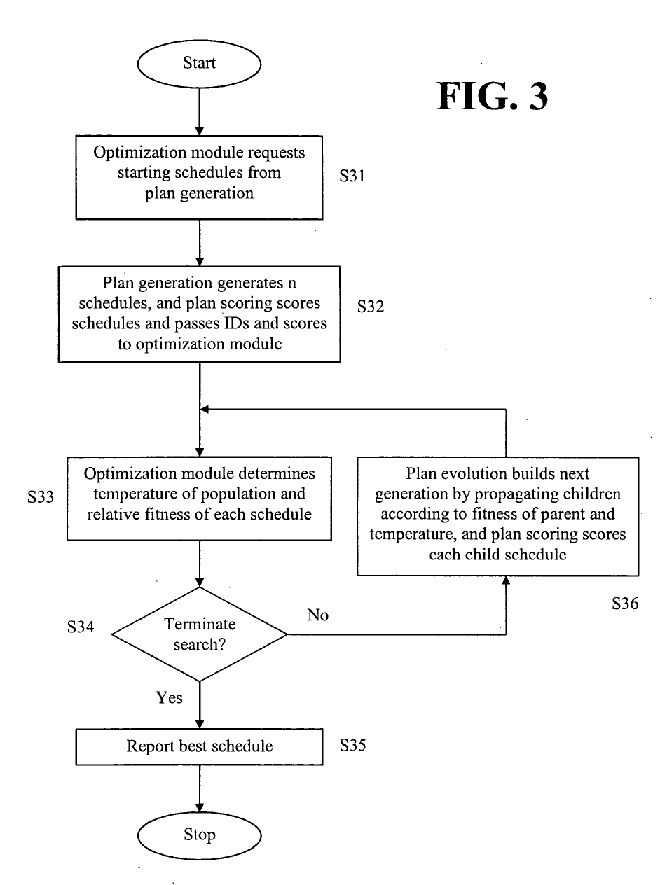

FIG. 3 shows a work flow for a scheduling task, according to an exemplary EPO embodiment. The optimization module requests starting schedules from the plan generation module (step S31). The plan generation module generates n (for example, a predetermined or selected number) schedules, and the plan scoring module scores the schedules and passes identifications and scores to the optimization module (step S32). The optimization module determines the temperature of the population and the relative fitness of each schedule (step S33). If the temperature and fitness is not satisfactory (step S34, No), the plan evolution module builds next generation by propagating children according to fitness of parent and temperature, and the plan scoring module scores each child schedule (step S36). Steps S33 and S34 are repeated. On the other hand, if the temperature and/or fitness are adequate (step S34, Yes), the best schedule is reported (step S35).

The EPO approach can be illustrated with a real application example, albeit one in much reduced scale. The example concerns scheduling games in a season for a fictitious sports league. The goal of the final schedule is to maximize the total “drawing value” of the games while minimizing the travel for the teams. A detailed description of the problem and application of the EPO on it is given below.

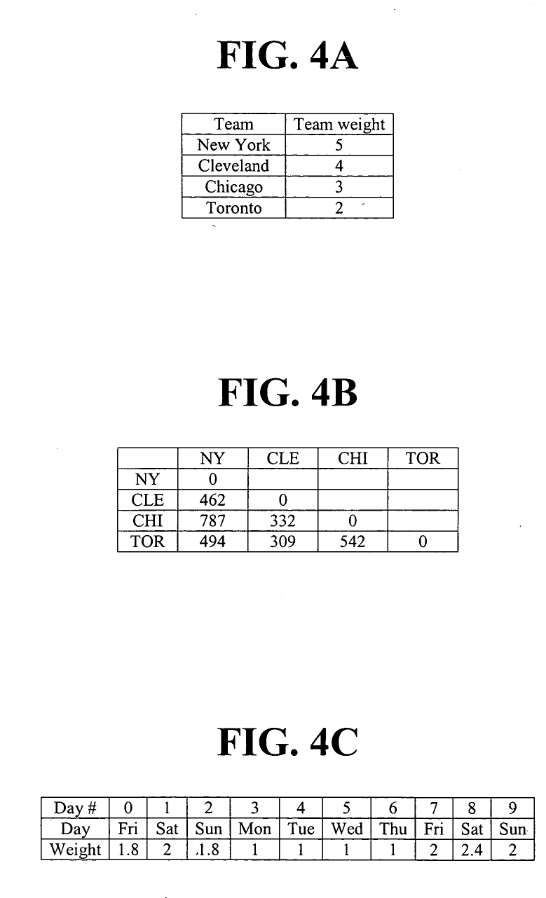

Suppose there are four teams in the sports league reside in respective cities with respective weights for drawing value as shown in FIG. 4A.

Also suppose the teams travel via direct flights and the table shown in FIG. 4B gives the distances in miles between the cities.

Further suppose the season is ten days long and starts on a Friday and ends on a Sunday. Since weekend days usually draw more people to the games, and more people tend to watch the games later in the season, the table shown in FIG. 4C shows the weights of each day of season for computing the drawing values.

A valid schedule also meets all of the following game rules:
1. Each team plays 2 games with every other team with one at home, one away.
2. Each team plays no more than once a day.
3. At most there can be two days with no games.
4. Each team is at home city at beginning of season, goes back to home city at end of season, after each game a team normally goes from current game city to next game city directly. However, if there are two or more days between two away games for a team, that team goes back home first and then go to the next game city from home.

The goal is to strike a proper balance between the following two objectives:
1. Minimize total travel distance, D.
2. Maximize game draw value, i.e. better teams play together on weekends and later in season which can be simplified to the following:
   V=sum over days [day weight*sum over games on that day (home team weight \hat{ }2*visitor team weight )]

Given the weights on the two objectives, a single objective function can be represented as:
O=w1*D−w2*V*7

The two weights, w1, w2 are positive and can be varied to show different preferences. A factor of 7 is added to the V term to bring the two to similar scales so that if weights are chosen to be 1, 1 the optimization result balances to two requirements. With this objective function the goal is to minimize value of O.

With the above description of the problem, it can be seen that the problem is really defined by a set of rules. The EPO approach applies those rules directly in the plan generation, evolution and scoring modules in the following manner.

The plan representation is simply which teams play on what dates. The plan representation is much more intuitive than the bit string of a traditional GA technique.

The plan scoring module can be implemented most straightforwardly by the prescribed objective function. The plan generation module was initially created following the simplest design, i.e. using random values where no rule applies. It was found that two simple evolution rules were found to be sufficient for the plan evolution module.

The first rule is to select a team at random from an existing plan, and then to select one of the selected team's opponents. Then the Home and Away games are switched for the selected opponent. Other than updating the opponent's schedule as well, the first rule can be unconditionally applied.

The second rule is to randomly select a team then select one of its game days at random, and also one of its Off days at random. Then it is attempted to switch the game day with the off day. Application of the second rule can be blocked if the opponent for the selected game day is busy on the selected Off day, in which case a different Off day is selected. If all Off days are exhausted without being able to effect the switch, another opponent is selected and the process repeated. If no game days can be switched with Off days for the original team selected, then another team is selected, and again the process repeated. Eventually a switch can be made between some game day and some Off day, for some team.

The results of the EPO approach in this example were quite good. In all combinations of the values of w1 and w2 from 1 to 10 in the objective function, the EPO approach obtained the same results as a different GA like implementation where the schedule is in an encoded form in all cases but one in which the EPO results was even slightly better.

However, the EPO approach used much longer execution time compared with the encoded version, although the optimal result was still obtained on the order of minutes running on a 2.2 GHz PC. Just to illustrate that introducing heuristic may improve the results, the following simple heuristic rule was added to the plan generation module. The rule is that better teams were scheduled on better days first. With the heuristic rule applied, the quality of the initial plans is considerably better and caused the reduction of around 12% on average in search time. The heuristic rule is only applied during the generation of the initial plans, and not used to limit the random evolution of the plans. A side benefit of EPO is that it usually generates a large pool of good to excellent plans, which can then be “mined” for heuristic rules. Such heuristics can then be leveraged to improve future EPO runs. For example, human inspection of the pool of good baseball plans yielded another heuristic related to travel cost minimization. The additional heuristic is that every team attempts to schedule all its road games in succession, and to utilize a circular route to travel to those road games.

More domain knowledge may yield additional heuristic rules that further improve the efficiency of the EPO approach. Rules that can be used in the plan evolution module that prevents it from evolving to bad problem spaces from domain knowledge are especially useful since they are far more effective in improving efficiency than a rule that can only be applied in the plan generation module.

EPO has successfully been applied to a scheduling problem, wherein a specified number of sports teams are to be scheduled for home and away games over a specified period of time. The schedules are scored on the basis of the “draw value” of the game given numeric ratings for each team and for each day of the “season”, and on the total distance traveled by all teams. Two simple evolutionary rules were defined for the prototype: switching home and away games for a given opponent; and switching a game day and off day at random. The optimal schedules obtained using EPO, on the basis of schedule score alone, are equivalent to those obtained using a traditional GA encoding. While processing time was considerably slower than when using the GA encoding, it was still on the order of tens of minutes with state-of-the art personal computers (for example, 2 GHz processors). Testing also showed improvement in processing speed when heuristics were incorporated into schedule generation. Further heuristics can be envisioned for the scheduling problem discussed above, and further speed enhancements are thus achievable.

The parallels between the exemplary scheduling problem discussed above and many other planning/scheduling problems are clear. The problem can be represented in a natural and intuitive manner. Even manual systems can be quickly represented within EPO, quickly resulting in optimal or near-optimal plans. And always there is clear direction for refinement of the system by adding heuristics to plan generation.

The practical limitation of the EPO approach is the time allotted to make a decision based upon the optimal plan to be generated. For a moderately complex problem like the sports scheduling problem, EPO can achieve processing speeds on the order of a few minutes. For highly complex plans, processing speeds on the order of an hour might be projected. With the advent of faster processors the projection might be halved or quartered in the not-too-distant future. In any case, it can generally be said that EPO can generate usable optimal plans in a matter of hours or less.

For the right domain, EPO can approximate a real-time solution given a highly optimized PRA component. Real-time here is taken to mean reporting results on the order of a minute or less. If the optimality condition is modified to “marked improvement within an allotted time”, then EPO can often serve as the basis for real-time planning and decision making.

The above specific embodiments are illustrative, and many variations can be introduced on these embodiments without departing from the spirit of this disclosure or from the scope of the appended claims. Elements and/or features of different illustrative embodiments may be combined with and/or substituted for each other within the scope of the disclosure and the appended claims.

For example, additional variations maybe apparent to one of ordinary skill in the art from reading U.S. Provisional Application Ser. No. 60/487,035, filed Jul. 11, 2003, which is incorporated herein in its entirety by reference.

1. A method for plan generation, comprising:
(a) generating one or more initial plans;
(b) evaluating the plans to determine quality scores for the plans;
(c) selecting one or more of the plans according to the quality scores and modifying the selected plans to generate modified plans;
(d) evaluating the modified plans to determine updated quality scores for the modified plans; and
(e) determining whether at least one of the modified plans is satisfactory.

2. The method of claim 1, wherein validity rules are used to generate the initial plans.

3. The method of claim 1, wherein at least one of the initial plans is generated by applying heuristics.

4. The method of claim 1, wherein at least one of the initial plans is generated randomly.

5. The method of claim 1 further comprising assessing whether the modified plans are valid plans.

6. The method of claim 1, wherein at least one of the modified plans is generated by applying evolution rules.

7. The method of claim 1, wherein a parameter corresponding to an amount of change is applied to generate at least one of the modified plans.

8. The method of claim 1, wherein at least one of the modified plans is generated using Guided Evolutionary Simulated Annealing.

9. The method of claim 1 further comprising repeating (c) through (e) until at least one of the modified plans is satisfactory.

10. The method of claim 1, wherein a modified plan is satisfactory if the quality score of the modified plan is a satisfactory value.

11. The method of claim 1, wherein a modified plan is satisfactory if a quality score of the modified plan converges.

12. An apparatus for plan generation, comprising:
a planning module adapted to generate one or more plans, evaluate the plans to determine quality scores for the respective plans, select one of the plans based on the quality scores, and modify the selected plan to generate one or more modified plans; and
an optimization module adapted to drive the planning module to develop a satisfactory plan.

13. The apparatus of claim 12, wherein the planning module includes a plan generation submodule for generating valid plans.

14. The apparatus of claim 13, wherein the plan generation submodule generates the valid plans by applying heuristics.

15. The apparatus of claim 13, wherein the plan generation submodule generates the valid plans by applying validity rules.

16. The apparatus of claim 12, wherein the planning module includes a plan evolution submodule for modifying the selected plan to generate the one or more modified plans.

17. The apparatus of claim 16, wherein the plan evolution submodule applies evolution rules to generate the modified plans.

18. The apparatus of claim 16, wherein the plan evolution submodule applies a parameter corresponding to an amount of change to generate the modified plans.

19. The apparatus of claim 12, wherein the planning module includes a plan scoring submodule for evaluating a plan to determine a quality score for the plan.

20. The apparatus of claim 12, wherein the satisfactory plan has a satisfactory associated quality score.

21. A computer system, comprising:
a processor; and
a program storage device readable by the computer system, tangibly embodying a program of instructions executable by the processor to perform the method claimed in claim 1.

22. A program storage device readable by a machine, tangibly embodying a program of instructions executable by the machine to perform the method claimed in claim 1.

23. A computer data signal transmitted in one or more segments in a transmission medium which embodies instructions executable by a computer to perform the method claimed in claim 1.
